(19) United States
(12) Patent Application Publication
(10) Pub. No.: US 2003/0014596 A1
(43) Pub. Date: Jan. 16, 2003

(54) Streaming data cache for multimedia processor

(76) Inventor: Naohiko Irie, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/903,008

(22) Filed: Jul. 10, 2001

(51) Int. Cl. G06F 12/00

(52) U.S. Cl. 711/133; 711/214

(57) ABSTRACT

A system is provided for improving the performance of multimedia computer operations. It includes a streaming data cache memory, a bus, a processor coupled to the bus, and an interface circuit coupled to the bus and to an external source of information, for example, a high speed communications link. The streaming data cache is coupled to a memory controller, and receives data only from the external source of information. After data in the streaming data cache memory is accessed the first time, the data is invalidated and not used again.

### BACKGROUND OF THE INVENTION

This invention relates to computing systems, and in particular, to a computing system specially adapted to multimedia applications. The adaptation includes provision of a special cache memory for handling streaming data.

Applications for microprocessors are continuing to increase rapidly. The advent of the internet has enormously increased the widespread availability of data to users all over the world. Such users are typically connected to the internet or other communications media through various communications links, ranging from modems to special purpose telephone lines, and now through fiber optic cables. The resulting increased bandwidth of the communications links provides the capability for users to receive and transmit more data per unit time than ever before.

One particularly intensive use of such processors and communications is multimedia applications. In multimedia applications large amounts of data in the form of audio (e.g. MP3, AAC), video (e.g. MPEG2, MPEG4), and other formats passes over the communications links between the user's systems and the originating source of the data. It is desirable for the user's system to have a processor which has enough performance to handle these data formats. One way to obtain enough performance from such processors is to continue to increase the frequency of the clock signals supplied to the processor, thereby enabling it to perform more processing steps per unit of time, which increases the performance of the system. Unfortunately, however, the clock frequency of devices coupled to the processor, for example, the system memory, usually DRAM, or other input/output devices, has not kept pace with this trend. Because the cost of packaging dominates the total chip cost in many applications, the number of input/output pins cannot be increased as fast as would otherwise be desirable. As a result, the gap between the requirements for the processor and the bandwidth of the system increases.

Another approach to increasing performance has been to provide multiple processors on a single die. Unfortunately, this approach increases the data bandwidth requirement between the processor and the memory, exacerbating the above problem. One prior art solution to this problem is to include a scratchpad memory which allows direct access from a DMA controller. One example of this technique is the X/Y memory of Hitachi's SH3-DSP. In such circumstances data can be fed directly to the chip, and the processor can access the data quickly. To control the memory, however, the operating system, the compiler or programmers, need to know the size of the scratchpad memory, which is dependent upon the particular chip employed. Adapting such situations to generally available software is difficult.

Another approach is to use cache memories which are shared for processor and I/O data. These solutions, however, because the I/O data has a bigger working set and tends not to be reused cause cache pollution and processor data to be kicked out. Yet another solution is to use embedded DRAM, in which main memory is placed on the same chip as the processor. Such an approach reduces the bandwidth gap between the processor and the main memory because the latency of the DRAM is reduced, and the number of pins for input/output operations can be increased. But the process technology for the processor portion of the chip is different from that desired for use on the DRAM portion of the chip, resulting in a trade-off which results in lower frequency operation of the processor. What is needed is a solution to solve the problem of memory bandwidth for multiple processors on a single die.

### SUMMARY OF THE INVENTION

This invention provides an enhanced solution to the problem of multimedia applications, and their interaction with the communications link having high bandwidth. Typically, the source of data for a multimedia application is known as a “stream” which originates from an outside the user's system, such as the internet. The streaming data tends not to be reused, so the efficiency of a conventional cache memory is generally poor. This invention provides a different type of cache memory, typically on the same die as a processor. This new type of cache memory, referred to herein as a streaming data cache memory, is located between the processor and the main memory.

A system employing the special purpose cache memory of this invention typically includes a bus, a processor coupled to the bus, and an interface circuit coupled to the bus and to an external source of information, for example, a high speed communications link. A memory controller is also coupled to the bus and to an external memory. The streaming data cache according to this invention is then coupled to a memory controller, and the cache memory itself receives data only from the external source of information or from the processor with special tag. Furthermore, the system is configured in a manner such that after the data in the streaming data cache memory is accessed the first time, the data is invalidated and not used again.

### BRIEF DESCRIPTION OF THE DRAWINGS

FIG. 1 is a block diagram illustrating a system according to a preferred embodiment of this invention; and

FIG. 2 is a more detailed diagram illustrating the configuration of the streaming data cache shown in FIG. 1.

### DESCRIPTION OF THE SPECIFIC EMBODIMENTS

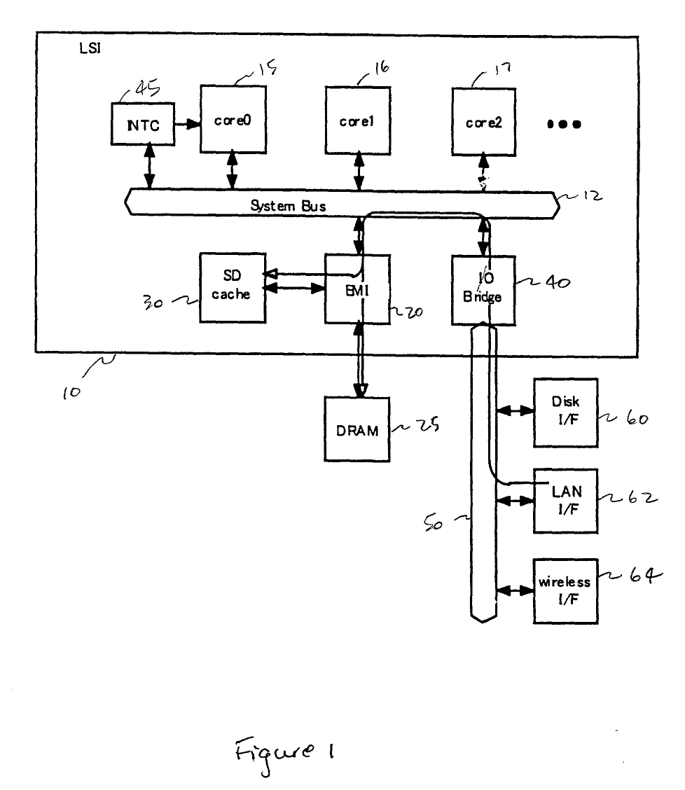

As described above, this system provides a solution to improve the efficiency of multimedia software by providing a streaming data cache, preferably on the same integrated chip as the processor. FIG. 1 is a block diagram of a preferred embodiment. As shown in FIG. 1, an integrated circuit 10 includes a system bus 12 which provides interconnections among the various functional units on the integrated circuit. System bus 12 can be a conventional bus, or it can be a switch-based interconnection. Connected to the bus are a desired number of central processing unit cores 15, 16, 17, . . . . The CPU cores may include arithmetic units, instruction and data cache memories, a floating point unit, a instruction flow unit, a translation lookaside buffer, a bus interface unit, etc. The configuration of these cores and their interconnections to the bus are well known, exemplified by many RISC processors, such as the Hitachi SH-5. These cores may provide multi-processor capabilities, such as bus snooping or other features for maintaining the consistency of the TLB. These capabilities are also well known.

Also connected to the system bus is an external memory interface unit (EMI) 20. This external memory interface unit controls the system memory 25, such as DRAM, which is coupled to the EMI 20. In addition, the external memory interface unit 20 also controls the streaming data cache or SD cache 30, which is one of the features of this invention.

Also preferably formed on the same chip 10 is an input/output bridge 40. Bridge 40 transfers I/O requests and data to and from modules that are not on the integrated circuit chip 10. I/O bridge 40 also receives data from these external modules and places it into the system main memory 25 using the external memory interface 20. Also formed on the same chip 10 is an interrupt controller 45. Interrupt controller 45 receives interrupt signals from the I/O bridge 40 or from other components outside the processor chip. The interrupt controller informs the appropriate cores 15, 16 or 17, as interrupt events occur.

Via an appropriate bus or communications interface, I/O bridge 40 is coupled to suitable external units which may provide data to the processor. These external units can include any known source of data. For illustrative purposes, however, depicted are a disk unit 60, a local area network 62, and a wireless network 64. Of course, depending upon available die space, the interfaces to these external units 60, 62 and 64 may be placed on the same die 10 as the remainder of the system. Because DRAM 25 typically consists of a substantial amount of random access memory, it is preferably implemented in the form of a memory module or separate memory chips coupled to the external memory interface 20.

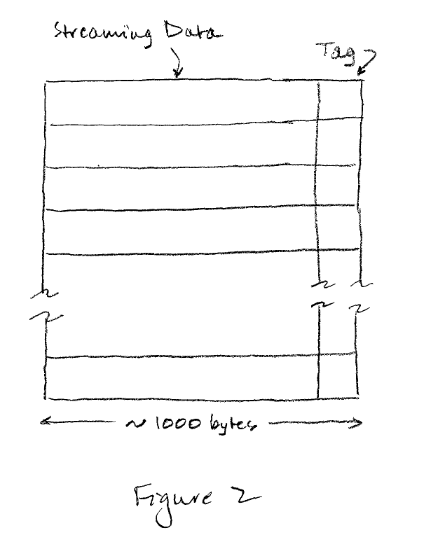

FIG. 1 includes a series of bidirectional arrows illustrating communications among the various components with the system bus, I/O bridge bus, etc. In addition to these arrows, however, there is a line extending from the LAN interface 62 to the I/O bridge, etc. This line is intended to depict the operation of the streaming data (herein often “SD”) cache 30. The streaming data cache 30 preferably comprises SRAM memory. The SRAM memory does not require refreshing, and operates at very high speeds. As shown in FIG. 2, the streaming data cache has a very large line size, for example, on the order of 1000 bytes or greater, each line in the cache includes a portion for the streaming data and a portion for the tag, that is, the address of that portion of the streaming data. The precise size of the line in the streaming data is somewhat arbitrary, and will generally depend upon the granularity of the data as controlled by the operating system. The system assumes that all data in the streaming data cache will be accessed only once. Thus, once the data is accessed, the line is invalidated automatically, making that line of the cache available for the next chunk of data arriving at the streaming data cache 30.

Next, with reference to FIG. 1, the operation of the streaming data cache will be described. First, assume that one of the core units 15, 16 or 17 invokes a direct memory access session which sets control registers inside the I/O bridge 40. I/O bridge 40 then detects arrival of data from off the chip. The bridge sends this data to the external memory interface unit 20 with a special tag. This tag is used to designate that the data arriving at the external memory interface 20 comes from the I/O bridge 40 and not from some on-chip unit such as one of the other cores.

The external memory interface unit receives the data and writes it into the system memory 25. In addition, if there is an empty line in the SD cache 30, the external memory interface 20 will write the data into that empty line in SD cache 30. If there are no empty lines in SD cache 30, the EMI 20 does not try to put this data into the streaming data cache. Thus, in effect, the streaming data cache keeps the head of I/O data which is not used.

The process above of writing data into the SD cache 30 continues until the I/O buffer is full. The size of the I/O buffer is typically a logical size, as opposed to a physical size. This logical size is determined for each I/O session and is controlled by the operating system.

As data arrives into the SD cache 30, eventually it will fill a complete line of the cache, and that line will then be designated as valid. The determination of when a complete line is filled can be performed by a simple counter, or more complex solutions such as bitmaps can be employed.

Once a line is valid, that information is conveyed by the external memory interface 20 back to the I/O bridge 40. The I/O bridge 40 then sends an interrupt signal which is detected by the interrupt controller 45. Controller 45 passes that interrupt event information on to the appropriate core 15, 16 or 17. That core then becomes active and begins taking steps to process the newly-arrived data.

The first step the core performs is to fetch data by sending a read request to the external memory interface 20. This read request will cause the external memory interface 20 to check the status of the SD cache 30. If the SD cache 30 has data related to the requested address, then the external memory interface 20 returns data from the SD cache 30 to the core, rather than returning data from the DRAM 25. At the time these operations are performed, the external memory interface also decrements the counter for this particular line of the cache (or negates a corresponding bit in the bit map). Once the counter or bitmap indicate that all information in that line of the cache has been used, the external memory interface unit 20 invalidates that line of the cache.

The preceding example has assumed that the data is available in the SD cache 30. If the data is not available in the SD cache 30, then the EMI 20 reads the data from the external DRAM 25. Unlike prior art cache memories, at the time the memory interface unit 20 reads this data from the external DRAM, it does not place a copy in the SD cache 30.

As has been described, this invention provides unique advantages in contrast to prior art solutions. In particular, with the streaming data cache there is no need for making read requests to the main memory if there is a hit in the streaming data cache. Thus, the bandwidth requirements on the external DRAM, or other system memory, become smaller. Furthermore, if the streaming data cache is formed using SRAM memory cells on the same chip as the processor, its access latency will be much smaller than DRAM access. This alone provides a dramatic improvement in performance. Furthermore, because of the particular configuration by which the invention is implemented, the streaming data cache is transparent from the point of view of the operating system or the applications programmer. Therefore, its presence does not affect the portability of software, or software development.

The streaming data cache may also have other applications on the chip. For example, in many multiprocessor applications targeting multimedia, the microprocessor cores provide a functional pipeline. To implement MPEG2 decoding, the various cores will perform different operations, for example a core 15 performs VLD (variable length decoding) and the other core 16 performs IDCT and the rest of cores performs Motion Compensation. The streaming data cache may be used to accelerate the data transfer between the cores. If such a feature is desired, a special but well-known instruction can be used. This special instruction causes the appropriate core to write data back from the data cache inside a CPU core 15-17 into main memory 25. When this instruction is issued the writeback data is put to DRAM via system bus 12 and external memory interface 20 with special tag. The external memory interface 20 checks this special tag and put the writeback data to SD cache 30. This enables to use the SD cache as a communication buffer between CPU cores 15-17. For example, the CPU core 15 ends to perform VLD, then the data after VLD is pushed back to main memory 25 using the special instruction described above. So the data after VLD is kept SD cache. The core 16 which performs IDCT requires the data after VLD, so it sends read request to external memory interface 20. The external memory interface 20 checks the status of the SD cache 30 and if it hits external memory interface returns the data from SD cache. This mechanism helps reducing memory bandwidth requirement.

The preceding has been a description of the preferred embodiment of the invention. It will be appreciated that deviations and modifications can be made without departing from the scope of the invention, which is defined by the appended claims.

What is claimed is:

1. A system comprising:
a bus;
a processor coupled to the bus;
an interface circuit coupled to the bus and to an external source of information;
a memory controller coupled to the bus and to an external memory; and
a cache memory coupled to the memory controller, the cache memory for storing only data received from the external source of information.

2. A system as in claim 1 wherein the cache memory stores data received from the external source of information, and after accessing the data a first time the data is invalidated and not used again.

3. A system as in claim 1 wherein the cache memory is prevented from storing information from the processor.

4. A system as in claim 2 wherein the cache has lines for storage of the data.

5. A system as in claim 4 wherein a tag provides an address for each set of data received from the external source of information.

6. A system as in claim 5 wherein the tag is stored in the memory controller to indicate whether the data is stored both in the cache and in the memory.

7. A system as in claim 6 wherein the cache lines hold at least 1000 bytes of information.

8. A system as in claim 1 wherein the processor and the cache are formed on the same integrated circuit.

9. A system comprising:
a bus;
a processor coupled to the bus;
an interface circuit coupled to the bus and to an external source of information;
a memory controller coupled to the bus and to an external memory; and
a cache memory coupled to the memory controller, and wherein
the cache memory stores data received from the external source of information; an
after accessing the data a first time the data is invalidated and not used again.

10. A system comprising:
a bus;
a processor coupled to the bus;
an interface circuit coupled to the bus and to an external source of information;
a memory controller coupled to the bus and to an external memory; and
a cache memory coupled to the memory controller, the cache memory for storing data received from the external source of information and having a line size which is at least 1000 bytes.

11. In a system having a bus, a processor coupled to the bus, an interface circuit coupled to the bus and to an external source of information, a memory controller coupled to the bus and to an external memory; and a cache memory coupled to the memory controller, a method for improving the handling of streaming data received from the external source comprising:
detecting the arrival of data from the external source of information;
storing the data in the cache and in the external memory;
in response to completion of the storage of the data, sending an interrupt signal to the processor; and
processing the data received from the external source.

12. A method as in claim 11 wherein the cache stores only data received from the external source of information.

13. A method as in claim 12 wherein data is stored in a line in the cache only until the memory controller indicates that the cache line is full.

14. A method as in claim 12 wherein a tag representing an address for the data received from the external source of information is stored in the memory controller, and wherein the processor checks the memory controller to determine whether the data is in the cache.

15. A method as in claim 14 wherein following retrieval of the data from the cache, a step is performed of invalidating the cache line.

16. A method as in claim 11 wherein if, at the time new data is to be stored in the cache there is not an empty line, one of the lines in the cache is reused for the new data.
